(19) United States
(12) Patent Application Publication
(10) Pub. No.: US 2025/0247645 A1
(43) Pub. Date: Jul. 31, 2025

(54) AUDIO CAPTURE

(71) Applicant: Nokia Technologies Oy, Espoo (FI)

(72) Inventors: Jussi Artturi LEPPÄNEN, Tampere (FI); Lasse Juhani LAAKSONEN, Tampere (FI); Arto Juhani LEHTINIEMI, Tampere (FI)

(21) Appl. No.: 19/016,043

(22) Filed: Jan. 10, 2025

(30) Foreign Application Priority Data
Jan. 25, 2024 (GB) 2400978.9

(51) Int. Cl. H04R 3/00; H04S 7/00

(52) U.S. Cl. CPC H04R 3/005; H04S 7/304; H04R 2430/20; H04S 2400/15

(57) ABSTRACT

Various example embodiments relate to audio capture of sound sources. For example, a method is disclosed comprising detecting, during transmission of first and second data streams to a destination terminal, wherein the first data stream carries audio of a first sound source captured by a first capture device, and the second data stream carries audio of a second sound source captured by a second capture device, that the first sound source is in proximity of the second capture device such that the second capture device is capable of capturing the audio of the first sound source. The method may also comprise suspending, at a particular time following said detection, transmission of the audio of the first sound source in the first data stream when the audio of the first sound source is captured by the second capture device and transmitted in the second data stream, the particular time being determined based on one or more characteristics of the audio captured by the first capture device and/or the second capture device.

### FIELD

Various example embodiments relate to audio capture of sound sources.

### BACKGROUND

Audio capture devices may capture audio from one or more sound sources, for example audio from one or more users. For example, a first audio capture device may comprise one or more microphones for capturing audio from a first user. For example, a second audio capture device may comprise one or more microphones for capturing audio from one or more second users. The first audio capture device may transmit a first audio stream to, or destined for, a destination terminal, the first audio stream comprising the captured audio of the first user. The second audio capture device may transmit a second audio stream to, or destinated for, the destination terminal, the second audio stream comprising the captured audio of the second user.

### SUMMARY

The scope of protection sought for various embodiments of the invention is set out by the independent claims. The embodiments and features, if any, described in this specification that do not fall under the scope of the independent claims are to be interpreted as examples useful for understanding various embodiments of the invention.

According to a first aspect, there is described an apparatus, comprising: means for detecting, during transmission of first and second data streams to a destination terminal, wherein the first data stream carries audio of a first sound source captured by a first capture device, and the second data stream carries audio of a second sound source captured by a second capture device, that the first sound source is in proximity of the second capture device such that the second capture device is capable of capturing the audio of the first sound source; and means for suspending, at a particular time following said detection, transmission of the audio of the first sound source in the first data stream when the audio of the first sound source is captured by the second capture device and transmitted in the second data stream, the particular time being determined based on one or more characteristics of the audio captured by the first capture device and/or the second capture device.

In some example embodiments, the particular time may be a time at which the second capture device captures audio from the second sound source.

In some example embodiments, the particular time may be a time at which the first capture device captures no audio from the first sound source.

In some example embodiments, the means for suspending transmission of the audio of the first sound source in the first data stream may be configured, at the particular time, to disable capture of the audio of the first sound source by the first capture device.

In some example embodiments, the apparatus may further comprise means for enabling capture of the audio of the first sound source by the second capture device at the particular time.

In some example embodiments, the means for suspending transmission of the audio of the first sound source in the first data stream may be configured to suspend transmission of the first data stream.

In some example embodiments, the apparatus may further comprise: means for further detecting, after suspending transmission of the first data stream, that the first sound source is no longer in proximity of the second capture device; and means for, responsive to said further detecting, resuming the transmission of the first data stream, wherein the audio of the first sound source is captured by the first capture device and transmitted in the first data stream.

In some example embodiments, the second capture device may comprise a spatial audio capture device for generating spatial audio data which comprises the captured audio of the first sound source, the captured audio of the second sound source and respective directional components for each said sound source.

In some example embodiments, the spatial audio capture device may comprise a plurality of microphones for capturing audio from different respective directions and wherein the respective directional components for the captured audio of each said sound source may be determined based on which of the microphones the captured audio of each said sound source is captured by.

In some example embodiments, the apparatus may further comprise: means for separating the captured audio of the first sound source and the second sound source into respective first and second sound objects; and means for transmitting the first and second sound objects and their respective directional components to the destination terminal.

In some example embodiments, the apparatus may comprise the second capture device.

In some example embodiments, the apparatus may comprise a network entity in communication with at least the second capture device.

According to a second aspect, there is described a method, comprising: detecting, during transmission of first and second data streams to a destination terminal, wherein the first data stream carries audio of a first sound source captured by a first capture device, and the second data stream carries audio of a second sound source captured by a second capture device, that the first sound source is in proximity of the second capture device such that the second capture device is capable of capturing the audio of the first sound source; and suspending, at a particular time following said detection, transmission of the audio of the first sound source in the first data stream when the audio of the first sound source is captured by the second capture device and transmitted in the second data stream, the particular time being determined based on one or more characteristics of the audio captured by the first capture device and/or the second capture device.

In some example embodiments, the particular time may be a time at which the second capture device captures audio from the second sound source.

In some example embodiments, the particular time may be a time at which the first capture device captures no audio from the first sound source.

In some example embodiments, suspending transmission of the audio of the first sound source in the first data stream may comprise, at the particular time, disabling capture of the audio of the first sound source by the first capture device.

In some example embodiments, the method may further comprise enabling capture of the audio of the first sound source by the second capture device at the particular time.

In some example embodiments, suspending transmission of the audio of the first sound source in the first data stream may comprise suspending transmission of the first data stream.

In some example embodiments, the method may further comprise: further detecting, after suspending transmission of the first data stream, that the first sound source is no longer in proximity of the second capture device; and responsive to said further detecting, resuming the transmission of the first data stream, wherein the audio of the first sound source is captured by the first capture device and transmitted in the first data stream.

In some example embodiments, the second capture device may comprise a spatial audio capture device for generating spatial audio data which comprises the captured audio of the first sound source, the captured audio of the second sound source and respective directional components for each said sound source.

In some example embodiments, the spatial audio capture device may comprise a plurality of microphones for capturing audio from different respective directions and wherein the respective directional components for the captured audio of each said sound source may be determined based on which of the microphones the captured audio of each said sound source is captured by.

In some example embodiments, the method may further comprise separating the captured audio of the first sound source and the second sound source into respective first and second sound objects; and transmitting the first and second sound objects and their respective directional components to the destination terminal.

In some example embodiments, the method may be performed by the second capture device.

In some example embodiments, the method may be performed by a network entity in communication with at least the second capture device.

According to a third aspect, there is described a computer program product, comprising a set of instructions which, when executed on an apparatus, is configured to cause the apparatus to carry out a method, comprising: detecting, during transmission of first and second data streams to a destination terminal, wherein the first data stream carries audio of a first sound source captured by a first capture device, and the second data stream carries audio of a second sound source captured by a second capture device, that the first sound source is in proximity of the second capture device such that the second capture device is capable of capturing the audio of the first sound source; and suspending, at a particular time following said detection, transmission of the audio of the first sound source in the first data stream when the audio of the first sound source is captured by the second capture device and transmitted in the second data stream, the particular time being determined based on one or more characteristics of the audio captured by the first capture device and/or the second capture device.

In some example embodiments, the third aspect may include any other feature mentioned with respect to the method of the second aspect.

According to a fourth aspect, there is described an apparatus comprising at least one processing core, at least one memory including computer program code, the at least one memory and the computer program code being configured to, with the at least one processing core, cause the apparatus to: detect, during transmission of first and second data streams to a destination terminal, wherein the first data stream carries audio of a first sound source captured by a first capture device, and the second data stream carries audio of a second sound source captured by a second capture device, that the first sound source is in proximity of the second capture device such that the second capture device is capable of capturing the audio of the first sound source; and suspend, at a particular time following said detection, transmission of the audio of the first sound source in the first data stream when the audio of the first sound source is captured by the second capture device and transmitted in the second data stream, the particular time being determined based on one or more characteristics of the audio captured by the first capture device and/or the second capture device.

In some example embodiments, the fourth aspect may include any other feature mentioned with respect to the method of the second aspect.

### DRAWINGS

Example embodiments will be described, by way of non-limiting example, with reference to the accompanying drawings, in which:

FIG. 1 illustrates a system providing an audio call between first and second users;

FIG. 2 illustrates a first capture device for capturing audio of the first user;

FIG. 3 illustrates a system providing an audio call involving first, second users and third users;

FIG. 4 illustrates part of a second capture device for capturing audio of the third user;

FIG. 5 illustrates the FIG. 3 system at a first time when the first user is in proximity of the second capture device;

FIG. 6 illustrates the FIG. 3 system at a second time, prior to the first time, when the first user is initially in proximity of the second capture device;

FIG. 7 illustrates an effect on captured audio of the first user, when switched from the first capture device to the second capture device, at the second time;

FIG. 8 is a flow diagram showing operations in accordance with one or more example embodiments;

FIG. 9 illustrates first and second sound waves representing audio captured by the respective first and second capture devices;

FIG. 10 illustrates an effect on captured audio of the first user, when switched from the first capture device to the second capture device, at a particular time determined in accordance with one or more example embodiments;

FIG. 11 is a block diagram of an apparatus that may be configured in accordance with one or more example embodiments; and

FIG. 12 illustrates a non-transitory computer readable medium in accordance with one or more example embodiments.

### DETAILED DESCRIPTION

Various example embodiments relate to audio capture of sound sources. Various example embodiments may relate to an apparatus, method and computer program product for audio capture of a plurality of sound sources. The sound sources may comprise, but are not limited to, users. Audio (i.e., sound waves) produced by said users may comprise, but is not limited to, speech.

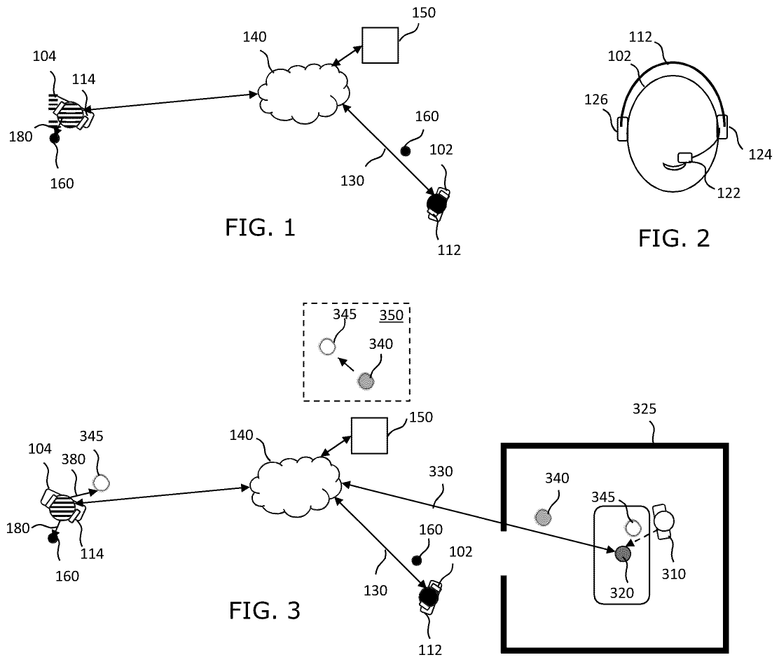

Referring to FIG. 1, first and second users 102, 104 may participate in an audio call. The first and second users 102, 104 may use respective first and second capture devices 112, 114 (hereafter “capture devices”) which may comprise one or more microphones for capture of audio produced by said users as part of the audio call. The one or more microphones may generate audio signals which represent the captured audio. The audio signals may be represented digitally as audio data after a process of analog-to-digital conversion (ADC).

The first and second capture devices 112, 114 may also comprise one or more loudspeakers for the output of the audio data received from the respective second and first capture devices during the audio call. The audio data may undergo a process of digital-to-analog conversion (DAC) prior to output by the one or more loudspeakers.

For example, the first and second capture devices 112, 114 may each comprise, but are not limited to, a user terminal, such as a mobile telephone, personal computer, laptop computer, tablet computer, a conference terminal or a head-worn device such as a set of earphones, earbuds, headphones or similar. The first and second capture devices 112, 114 may be of the same type or of different types.

FIG. 2 shows an example first capture device 112 which is a head-worn device. The first capture device 112 may comprise a microphone 122, and left and right-hand earphones 124, 126. The first capture device 112 may be capable of transmitting and receiving audio data, to and from a network 140, or may be in signal communication with an associated (or paired) communications device, for example a mobile telephone, which is capable of transmitting and receiving data to and from the network. For example, both the first capture device 112 and the associated mobile telephone may support a communications protocol such as, but not limited to, Bluetooth, Zigbee, WiFi or similar. For the avoidance of doubt, references to transmission and/or reception of audio data by the first capture device 112 (or any other capture device described herein) may also refer to transmission or reception by an associated communication device such as a mobile telephone.

The first and second capture devices 112, 114 may communicate directly or via the network 140. The latter situation will be assumed hereinafter.

The network 140 may comprise an internet protocol (IP) network or other form of communications network. Respective air interfaces between the first and second capture devices 112, 114 and the network 140 may be in accordance with a cellular, or non-cellular, radio access technology (RAT) that both the first and second capture devices and the network are configured to support. Examples of cellular RATs include Long Term Evolution (LTE) or fifth generation (5G) New Radio (NR) radio access technology, or 5G beyond, or sixth generation (6G) radio access technology or other communications technologies.

For ease of explanation, example embodiments mainly concern the transmission of audio data in one or more data streams which are destinated for the second capture device 114, in terms of its role as a destination terminal for part of the audio call. It will however be appreciated that audio data may be transmitted in the reverse direction from the second capture device 114 to, for example, the first capture device 112 as part of the audio call.

The first capture device 112 may transmit audio data to the second capture device 114 in a first data stream 130. In other words, the first data stream 130 carries the audio data captured and transmitted by the first capture device 112 and which is destined for the second capture device 114.

The first data stream 130 may be established using any suitable streaming protocol that the first and second capture devices 112, 114 are configured to support, such as the real-time streaming protocol, RTSP, real-time messaging protocol, RTMP, or dynamic adaptive streaming over HTTP, MPEG-DASH.

The first capture device 112 may transmit its audio data in the first data stream 130 via a network entity 150 which may operate as an intermediary device between the first capture device and the second capture device 114. That is, the network entity 150 may relay the audio data in the first data stream 130 to the second capture device 114. The network entity 150 may also perform one or more processing and/or control operations. The network entity 150 may comprise, for example, a cellular base station such as an eNB or gNB or a server which may comprise a part of the network 140.

In some example embodiments, audio captured by the first capture device 112 may be encoded with a spatial percept in order that the resulting audio data, when decoded and rendered by the second capture device 114, will be perceived as coming from a particular direction with respect to the second user 104.

For example, the first and second capture devices 112, 114 may be configured to support spatial audio capture and spatial audio rendering. For example, the first and second capture devices 112, 114 may support one or more spatial audio codecs for encoding/decoding the transmitted/received audio data using a particular spatial audio format.

Known spatial audio formats include channel-based formats, object-based formats and Ambisonics. Example embodiments may focus on object-based formats but are not limited to such. Object-based formats treat each sound source in the captured audio as an independent object with its own metadata, such as location, volume and/or direction. This allows the object to be rendered dynamically according to, for example, loudspeaker layout, listener position and the acoustic properties of the space in which the lister is located. A known spatial audio codec, mentioned by way of example, is the Immersive Voice and Audio Services (IVAS) codec which has been standardized by the 3^{rd} Generation Partnership Project (3GPP) for voice services. The IVAS codec may provide a universal codec for a range of different spatial audio formats, including but not limited to mono (using enhanced voice services (EVS)), stereo, object-based audio, Ambisonics, combined formats and/or Metadata-Assisted Spatial Audio (MASA) which is a parametric spatial audio format useful for direct user equipment (UE) pickup wherein the UE comprises a plurality of microphones.

Referring again to FIG. 1, audio from the first user 102 may be captured and encoded at the first capture device 112 using, for example, an object-based spatial audio codec. The object-based spatial audio codec may encode captured audio of a first object 160 (for example speech produced by the first user 102) in spatial audio data. The first capture device 112 may then transmit the spatial audio data in the first data stream 130 to the network entity 150 which may then relay the spatial audio data to the second capture device 114. The second capture device 114 may decode the spatial audio data and render the decoded first object 160, such that it will be perceived as coming from a particular first direction 180 with respect to the second user 104.

FIG. 3 illustrates a situation, wherein a third user 310 participates in the audio call with the first and second users 102, 104.

The third user 310 may use a third capture device 320 which may comprise one or more microphones for capture of audio, e.g., speech, produced by said third user as part of the audio call.

The third capture device 320 may also comprise one or more loudspeakers for the output of audio signals received from the first and second capture devices 112, 114 during the audio call.

The third user 310 and the third capture device 320 may be located in a particular space, e.g., a room 325.

For example, the third capture device 320 may comprise, but is not limited to, a user terminal, such as a mobile telephone, personal computer, laptop computer, tablet computer, conference terminal or a head-worn device such as a set of earphones, earbuds, headphones or similar.

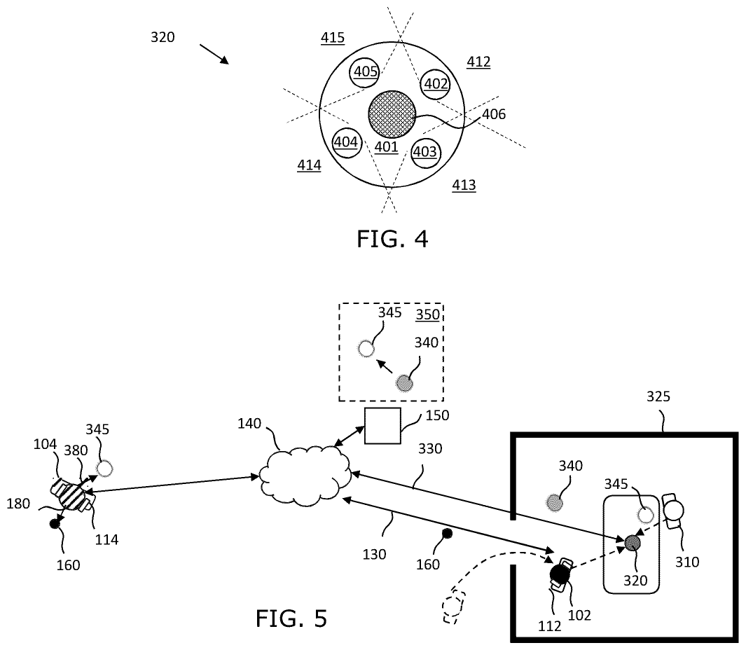

FIG. 4 shows an example third capture device 320 which may comprise a conference terminal. The third capture device 320 may comprise a body 401, an array of first to fourth microphones 402-405 having different respective positions and/or orientations on the body, and a loudspeaker 406. In some example embodiments, fewer, or a greater number of microphones may be provided.

The first to fourth microphones 402-405 may be positioned and/or oriented such as to capture audio predominantly from different respective directions or ranges of directions 412-415, some of which may overlap.

The third capture device 320 may communicate with the first and second capture devices 112, 114 via the network 140. This may by means of a cellular or non-cellular RAT, as explained above with reference to FIG. 1.

Example embodiments focus on the transmission of data by the third capture device 320 to the second capture device 114. It will however be appreciated that audio data may be transmitted in the reverse direction from the second capture device 114 to, for example, the third capture device 320 as part of the audio call.

The third capture device 320 may transmit its captured audio data in a second data stream 330 which is different from the first data stream 130. The second data stream 330 may use any suitable streaming protocol, examples of which are given above.

The third capture device 320 may communicate audio data in the second data stream 330 via the network entity 150 which may perform the above-mentioned relaying function.

Referring again to FIG. 3, audio from the third user 310 may be captured and encoded at the third capture device 320 using, for example, an object-based spatial audio codec. The object-based spatial audio codec may encode a second object 345 (for example captured speech of the third user 310) and possibly other audio such as ambient audio to produce spatial audio data 340. The third capture device 320 may then transmit the spatial audio data 340 such that it is carried in the second data stream 330 to the network entity 150 which may then relay the spatial audio data to the second capture device 114.

As indicated in box 350, the network entity 150 may also be configured, based for example on metadata provided with the spatial audio data 340, to separate the second object 345 from other audio of the spatial audio data. The network entity 150 may then transmit, or relay, at least the second object 345 to the second capture device 114. The second capture device 114 may decode and render the decoded second object 345, such that it will be perceived as coming from a particular second direction 380 with respect to the second user 104.

Alternatively, the above separation may be performed at the second capture device 114.

The first object 160 may be encoded, transmitted in the first data stream 130 and rendered as explained above.

FIG. 5 illustrates a situation, which may occur after that shown in FIG. 3, wherein the first user 102 changes spatial position such that they are proximate to the third capture device 320. For example, the first user 102 may walk into the room 325.

The third capture device 320 may now be capable of capturing audio of the first user 102. Thus, in some example embodiments, the third capture device 320 may capture, or be caused to capture, audio of the first user 102 and the third user 310 from different directions such that their respective captured audio can be transmitted in the second data stream 330.

The first data stream 130 can optionally be suspended at this time, at least temporarily, for efficient use of bandwidth. The second user 104 may receive an improved user experience because the respective audio of the first user 102 and the third user 310, when rendered, are likely to sound similar because they are captured by the same, third capture device 320.

Example embodiments may determine a particular time to suspend transmission of the audio of the first user 102 in the first data stream 130, wherein the captured audio of the first user can be transmitted in the second data stream 330.

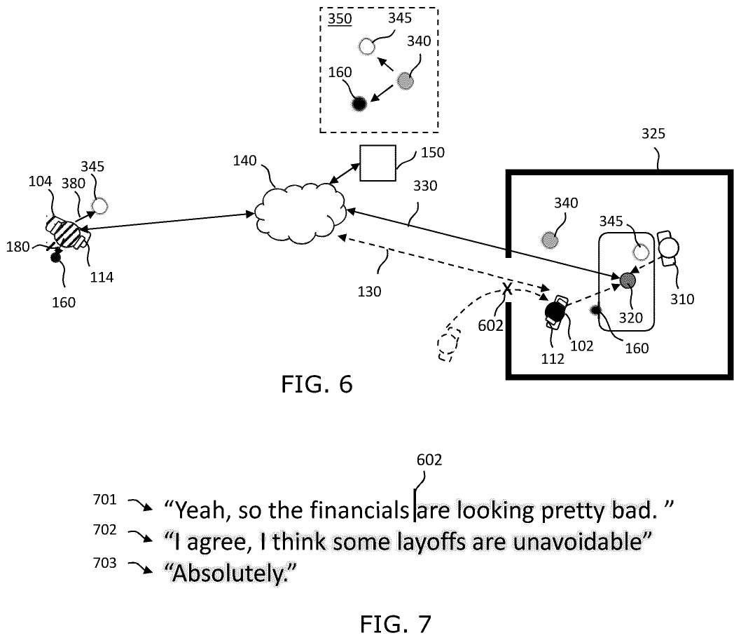

FIG. 6, for example, illustrates a situation wherein the particular time is a time when the first user 102 is first detected to be in proximity of the third capture device 320. This may occur, for example, when the first user 102 enters the room 325, indicated by “X” 602.

At this particular time 602, the first data stream 130 may be suspended, at least temporarily, such that no audio data is transmitted in the first data stream.

Additionally, or alternatively, the one or more microphones of the first capture device 112 may be disabled, at least temporarily, which also has the effect of no audio data being transmitted in the first data stream 130.

If not already enabled, one or more of the first to fourth microphones 402-404 of the third capture device 320 may be enabled, or have their sensitivity increased, for capturing the audio of the first user 102. For example, the third microphone 404 which may be closest to the position of the first user 102 may be enabled, or have its sensitivity/amplification increased. In this manner, capture of audio of the first user 102 is switched from the first capture device 112 to the third capture device 320. The third capture device 320 may produce spatial audio data 340 that is carried in the second data stream 330 to the network entity 150. The spatial audio data 340 may comprise the first and second objects 160, 345 representing speech produced by the first and third users 102, 310 respectively. In the course of a conversation, the first and second objects 160, 345 may be captured at different times and hence the spatial audio data 340 may change over time to reflect the first and second objects and their associated metadata.

As indicated in box 350, the network entity 150 may be configured, based for example on the metadata provided with the spatial audio data 340, to separate the first and second objects 160, 345 in the spatial audio data. The network entity 150 may then transmit, or relay, the first and second objects 160, 345 to the second capture device 114. The second capture device 114 may decode and render the decoded first and second objects 160, 345, such that they will be perceived as coming from respective first and second directions 180, 380 with respect to the second user 104.

Alternatively, the above separation may be performed at the second capture device 114.

However, if at this particular time 602, the first user 102 is producing audio, for example if the first user is mid-way through an utterance or sentence, the audio captured by the third capture device 320 and transmitted in the second data stream 330 may sound noticeably different to that captured by the first capture device 112 and transmitted in the first data stream 130.

FIG. 7 illustrates example utterances of a conversation, in which a first utterance 701 is produced by the first user 102, a second utterance 702 is produced by the third user 310, and a third utterance 703 is produced by the first user. It will be seen that the particular time 602 to suspend transmission in the first data stream 130 is mid-way through the first utterance 701. The remaining part of the first utterance 701, and the subsequent second and third utterances 702, 703 will likely sound noticeably different than the earlier part of the first utterance. This may be confusing or disturbing to the second user 104. Example embodiments may avoid or alleviate this unwanted effect.

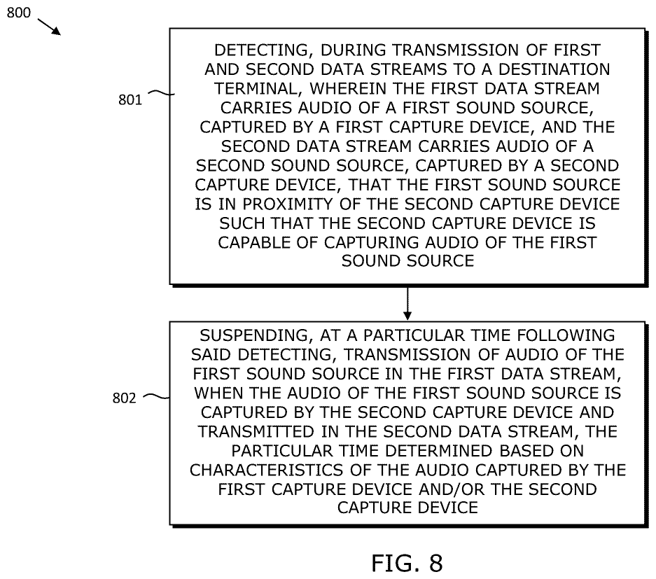

FIG. 8 is a flow diagram showing operations 800 according to one or more example embodiments. The operations 800 may be performed in hardware, software, firmware or a combination thereof. For example, the operations 800 may be performed individually, or collectively, by a means, wherein the means may comprise at least one processor and at least one memory storing instructions that, when executed by the at least one processor, cause the performance of the operations. The operations 800 may, for example, be performed by the network entity 150 of the above examples or by another device such as by the third capture device 320 of the above examples.

A first operation 801 may comprise detecting, during transmission of first and second data streams to a destination terminal, wherein the first data stream carries audio of a first sound source, captured by a first capture device, and the second data stream carries audio of a second sound source, captured by a second capture device, that the first sound source is in proximity of the second capture device such that the second capture device is capable of capturing audio of the first sound source.

With regard to the FIG. 6 example, the first capture device of the first operation 801 may comprise the first capture device 112, the second capture device of the first operation may comprise the third capture device 320 and the first and second sound sources of the first operation may comprise the first and third users 102, 310.

In some example embodiments, the audio of the first and second sound sources may comprise speech. In some example embodiments, the first and second data streams may be transmitted to the destination terminal via one or more intermediary devices, e.g., one or more network entities such as the network entity 150.

In some example embodiments, said detecting may comprise detecting, by the second capture device of the first operation 801, of an above-threshold level of audio from the first sound source.

For example, taking the FIG. 6 example, the third microphone 404 of the third capture device 320 may be enabled for detecting ambient sounds and, upon capture of an above-threshold level of audio from the first user 102, may detect that the first user 102 is now proximate to the third capture device 320.

Additionally, or alternatively, other means for detecting proximity may be used, e.g., by means of an infra-red and/or ultrasonic proximity sensor provided on one or other of the first and second capture devices of the first operation 801, and/or a camera on one or other of the first and second capture devices for detecting the presence of a nearby capture device.

A second operation 802 may comprise suspending, at a particular time following said detection, transmission of audio of the first sound source in the first audio stream, when the audio of the first sound source is captured by the second capture device and transmitted in the second audio stream, the particular time being determined based on one or more characteristics of the audio captured by the first capture device and/or the second capture device.

In some example embodiments, the particular time may be a time at which the second capture device of the first operation 801 captures audio from the second sound source.

Additionally, or alternatively, the particular time may be a time at which the first capture device of the first operation 801 captures no audio from the first user.

The particular time may therefore take into account the likelihood that, when the second sound source is producing audio, the first sound source is not producing audio. This may be the case when the first and second sound sources are users producing speech as part of a conversation.

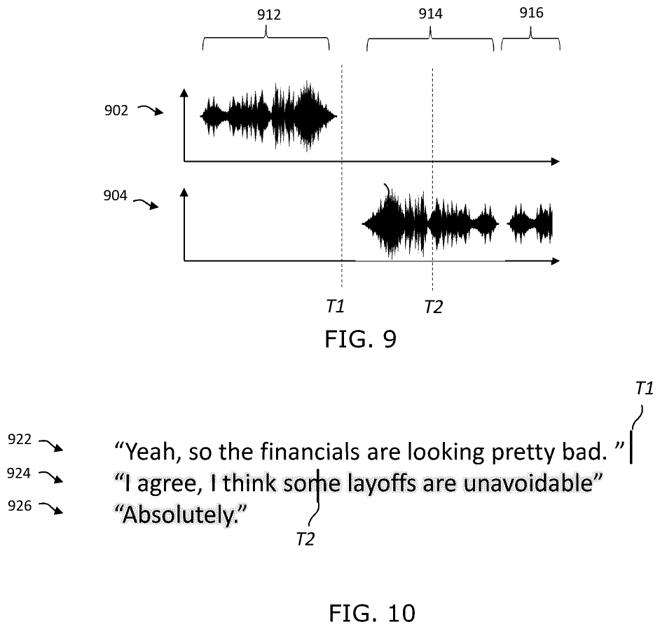

FIG. 9 shows first and second sound waves 902, 904 representing speech captured by the respective first and second capture devices. The first sound wave includes a first section 912 corresponding to a first utterance 922 of the first user (see FIG. 10) captured by the first capture device. The second sound wave includes a second section 914 corresponding to a second utterance 924 of the second user captured by the second capture device. The second sound wave also includes a third section 916 corresponding to a third utterance 926 of the first user captured by the second capture device.

FIGS. 9 and 10 also indicate different particular times T1, T2 that may be selected for the second operation 802.

A first particular time T1 may be a time at which no audio is captured by the first capture device nor by the second capture device. This corresponds to the end of the first utterance 922. Performing the second operation 802 at this time will avoid or alleviate the above unwanted effects; however, it requires knowledge of the audio captured by the first and second capture devices.

A second particular time T2 may be a time at which audio is captured by the second capture device. Performing the second operation 802 at this delayed time will avoid or alleviate the above unwanted effects and only requires knowledge of the audio captured by the second capture device, which may be the entity that performs the above operations 800 or which signals data to a network entity that performs the above operations.

It will be seen from FIG. 10 that the user of the destination terminal will hear consistent audio characteristics for the second and third utterances 924, 926, which is less confusing or disturbing and may also signal that the first and second audio sources are in the same space or room.

In some example embodiments, the second operation 802 of suspending transmission of audio of the first sound source may comprise disabling capture of the audio of the first sound source by the first capture device.

Alternatively, or additionally, example embodiments may further comprise enabling capture of the audio of the first sound source by the second capture device at the particular time. In other words, the particular time may refer to a switching time whereby the one or more microphones of the first capture device may be switched off and the one or more microphones of the second capture device may be switched on (if not already switched on).

Alternatively, or additionally, the second operation 802 of suspending transmission of audio of the first sound source may comprise suspending transmission of the first data stream.

In this case, after suspending the transmission of the first data stream, it may be further detected that the first sound source is no longer in proximity of the second capture device. In response to said further detection, transmission of the first data stream may be resumed, wherein the audio of the first sound source is again captured by the first capture device and transmitted in the first data stream. Suspending transmission of the first data stream in the second operation 802 may therefore be temporary. Alternatively, the first data stream may be dropped to save complexity and bandwidth.

In some example embodiments, the second capture device comprises a spatial audio capture device (such as the third capture device 320 of FIG. 6) for generating spatial audio data which comprises the captured audio of the first sound source, the captured audio of the second sound source and respective directional components for the captured audio of the first sound source and the captured audio of the second sound source. The spatial audio capture device may comprise a plurality of microphones, e.g., a microphone array, for capturing audio from different respective directions. The respective directional components for the captured audio of the first sound source and the captured audio of the second sound source may be determined based on which of the microphones the respective captured audio of the first sound source and second sound source is or are captured by. In some example embodiments, the captured audio of the first sound source and the second sound source may be separated into respective first and second sound objects which may be transmitted with their respective directional components to the destination terminal such that they will be rendered by the destination terminal such as to be perceived as coming from different respective directions with respect to a user of the destination terminal.

Example embodiments may be performed at the second capture device or a network entity is communication with the second capture device.

Example embodiments enable efficient use of transmission bandwidth and improved user experience, for reasons already mentioned herein.

### Example Apparatus

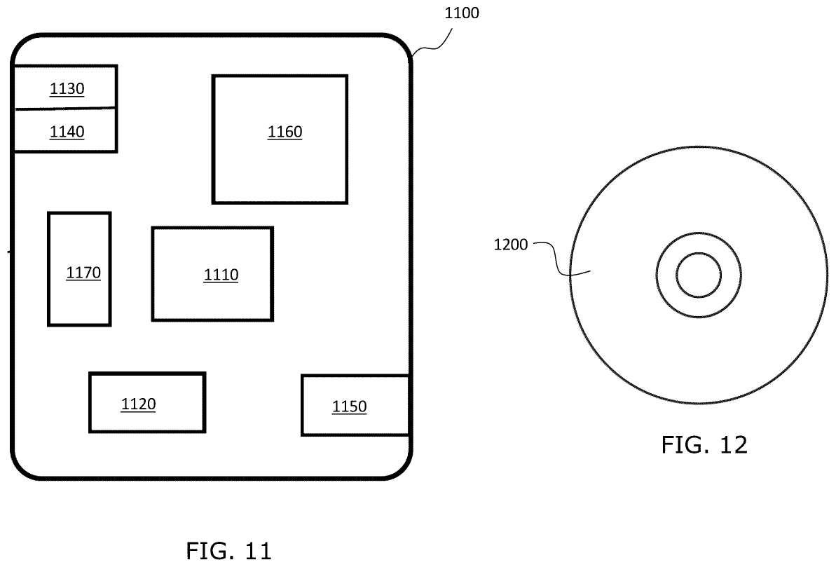

FIG. 11 illustrates an example apparatus 1100 capable of supporting at least some embodiments. Illustrated is a device 1100, which may comprise the second capture device referred to in the first operation 801 or a network entity in communication with the second capture device. Comprised in device 1100 is a processor 1110, which may comprise, for example, a single- or multi-core processor wherein a single-core processor comprises one processing core and a multi-core processor comprises more than one processing core. The processor 1110 may comprise, in general, a control device. The processor 1110 may comprise more than one processor. The processor 1110 may be a control device. A processing core may comprise, for example, a Cortex-A8 processing core manufactured by ARM Holdings or a Steamroller processing core produced by Advanced Micro Devices Corporation. The processor 1110 may comprise at least one Qualcomm Snapdragon and/or Intel Atom processor. The processor 1110 may comprise at least one Application-Specific Integrated Circuit, ASIC. The processor 1110 may comprise at least one Field-Programmable Gate Array, FPGA. The processor 1110 may be means for performing method steps in device 1100. The processor 1110 may be configured, at least in part by computer instructions, to perform actions.

A processor may comprise circuitry, or be constituted as circuitry or circuitries, the circuitry or circuitries being configured to perform phases of methods in accordance with embodiments described herein. As used in this application, the term “circuitry” may refer to one or more or all of the following: (a) hardware-only circuit implementations, such as implementations in only analog and/or digital circuitry, and (b) combinations of hardware circuits and software, such as, as applicable: (i) a combination of analog and/or digital hardware circuit(s) with software/firmware and (ii) any portions of hardware processor(s) with software (including digital signal processor(s)), software, and memory (ies) that work together to cause an apparatus, such as the network node 120, or a device configured to control the functioning thereof, to perform various functions) and (c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The device 1100 may comprise a memory 1120. The memory 1120 may comprise random access memory and/or permanent memory. The memory 1120 may comprise at least one RAM chip. The memory 1120 may comprise solid-state, magnetic, optical and/or holographic memory, for example. The memory 1120 may be at least in part accessible to processor 1110. The memory 1120 may be at least in part comprised in processor 1110. The memory 1120 may be means for storing information. The memory 820 may comprise computer instructions that processor 1110 is configured to execute. When computer instructions configured to cause the processor 1110 to perform certain actions are stored in the memory 1120, and the device 1100 overall is configured to run under the direction of the processor 1110 using computer instructions from the memory 1120, the processor 1110 and/or its at least one processing core may be considered to be configured to perform said certain actions. The memory 1120 may be at least in part comprised in the processor 1110. The memory 1120 may be at least in part external to the device 1100 but accessible to the device 1100.

The device 1100 may comprise a transmitter 1130. The device 1100 may comprise a receiver 1140. The transmitter 1130 and the receiver 1140 may be configured to transmit and receive, respectively, information in accordance with at least one cellular or non-cellular standard.

The transmitter 1130 may comprise more than one transmitter. The receiver 1140 may comprise more than one receiver. The transmitter 1130 and/or the receiver 1140 may be configured to operate in accordance with Global System for Mobile Communication, GSM, Wideband Code Division Multiple Access, WCDMA, 5G/NR, 5G-Advanced, i.e., NR Rel-18, 19 and beyond, Long Term Evolution, LTE, IS-95, Wireless Local Area Network, WLAN, Ethernet and/or Worldwide Interoperability for Microwave Access, WiMAX, standards, for example.

The device 1100 may comprise a Near-Field Communication, NFC, transceiver 1150. The NFC transceiver 1150 may support at least one NFC technology, such as NFC, Bluetooth, Wibree or similar technologies.

The device 1100 may comprise a User Interface, UI, 1160. The UI 1160 may comprise at least one of a display, a keyboard, a touchscreen, a vibrator arranged to signal to a user by causing device 1100 to vibrate, a speaker and a microphone. A user may be able to operate the device 1100 via the UI 1160, for example to accept incoming telephone calls, to originate telephone calls or video calls, to browse the Internet, to manage digital files stored in memory 1120 or on a cloud accessible via the transmitter 1130 and the receiver 1140, or via NFC transceiver 1150, and/or to play games.

The device 1100 may comprise or be arranged to accept a user identity module 1170. The user identity module 1170 may comprise, for example, a Subscriber Identity Module, SIM, card installable in device 1100. The user identity module 1170 may comprise information identifying a subscription of a user of device 1100. The user identity module 1170 may comprise cryptographic information usable to verify the identity of a user of device 1100 and/or to facilitate encryption of communicated information and billing of the user of the device 1100 for communication effected via device 1100.

The processor 1110 may be furnished with a transmitter arranged to output information from processor 1110, via electrical leads internal to the device 1100, to other devices comprised in the device 1100. Such a transmitter may comprise a serial bus transmitter arranged to, for example, output information via at least one electrical lead to the memory 1120 for storage therein. Alternatively to a serial bus, the transmitter may comprise a parallel bus transmitter.

Likewise the processor 1110 may comprise a receiver arranged to receive information in The processor 1110, via electrical leads internal to the device 1100, from other devices comprised in the device 1100. Such a receiver may comprise a serial bus receiver arranged to, for example, receive information via at least one electrical lead from the receiver 1140 for processing in the processor 1110. Alternatively to a serial bus, the receiver may comprise a parallel bus receiver.

The device 1100 may comprise further devices not illustrated in FIG. 11. For example, where the device 1100 comprises a smartphone, it may comprise at least one digital camera. Some devices 1100 may comprise a back-facing camera and a front-facing camera, wherein the back-facing camera may be intended for digital photography and the front-facing camera for video telephony. The device 1100 may comprise a fingerprint sensor arranged to authenticate, at least in part, a user of the device 1100. In some embodiments, the device 1100 lacks at least one device described above. For example, some devices 1100 may lack a NFC transceiver 1150 and/or user identity module 1170.

The processor 1110, memory 1120, transmitter 1130, receiver 1140, NFC transceiver 1150, UI 1160 and/or user identity module 1170 may be interconnected by electrical leads internal to the device 1100 in a multitude of different ways. For example, each of the aforementioned devices may be separately connected to a master bus internal to the device 1100, to allow for the devices to exchange information. However, as the skilled person will appreciate, this is only one example and depending on the embodiment various ways of interconnecting at least two of the aforementioned devices may be selected without departing from the scope of the present invention.

FIG. 12 shows a non-transitory media 1200 according to some embodiments. The non-transitory media 1200 is a computer readable storage medium. It may be e.g. a CD, a DVD, a USB stick, a blue ray disk, etc. The non-transitory media 1200 stores computer program instructions, causing an apparatus to perform the method of any preceding process for example as disclosed in relation to the flow diagrams in this specification and related features thereof.

The described features, structures, or characteristics may be combined in any suitable manner in one or more embodiments. In the preceding description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the forgoing examples are illustrative of the principles of the embodiments in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The verbs “to comprise” and “to include” are used in this document as open limitations that neither exclude nor require the existence of also un-recited features. The features recited in dependent claims are mutually freely combinable unless otherwise explicitly stated. Furthermore, it is to be understood that the use of “a” or “an”, that is, a singular form, throughout this document does not exclude a plurality.

1-14. (canceled)

15. An apparatus, comprising:
at least one processor; and
at least one memory storing instructions that, when executed by the at least one processor, cause the apparatus at least to:
detect, during transmission of first and second data streams to a destination terminal, wherein the first data stream carries audio of a first sound source captured by a first capture device, and the second data stream carries audio of a second sound source captured by a second capture device, that the first sound source is in proximity of the second capture device such that the second capture device is capable of capturing the audio of the first sound source; and
suspend, at a particular time following said detection, transmission of the audio of the first sound source in the first data stream when the audio of the first sound source is captured by the second capture device and transmitted in the second data stream, the particular time being determined based on one or more characteristics of the audio captured by at least one of the first capture device or the second capture device.

16. The apparatus of claim 15, wherein the particular time is a time at which the second capture device captures audio from the second sound source.

17. The apparatus of claim 15, wherein the particular time is a time at which the first capture device captures no audio from the first sound source.

18. The apparatus of claim 15, wherein suspending transmission of the audio of the first sound source in the first data stream comprises, at the particular time, disabling capture of the audio of the first sound source by the first capture device.

19. The apparatus of claim 18, wherein the apparatus is further caused to enable capture of the audio of the first sound source by the second capture device at the particular time.

20. The apparatus of claim 15, wherein suspending transmission of the audio of the first sound source in the first data stream comprises suspending transmission of the first data stream.

21. The apparatus of claim 20, wherein the apparatus is further caused to:
further detect, after suspending transmission of the first data stream, that the first sound source is no longer in proximity of the second capture device; and
responsive to said further detecting, resume the transmission of the first data stream, wherein the audio of the first sound source is captured by the first capture device and transmitted in the first data stream.

22. The apparatus of claim 15, wherein the second capture device comprises a spatial audio capture device for generating spatial audio data which comprises the captured audio of the first sound source, the captured audio of the second sound source and respective directional components for each said sound source.

23. The apparatus of claim 22, wherein the spatial audio capture device comprises a plurality of microphones for capturing audio from different respective directions and wherein the respective directional components for the captured audio of each said sound source are determined based on which of the microphones the captured audio of each said sound source is captured by.

24. The apparatus of claim 22, wherein the apparatus is further caused to:
separate the captured audio of the first sound source and the second sound source into respective first and second sound objects; and
transmit the first and second sound objects and their respective directional components to the destination terminal.

25. The apparatus of claim 15, wherein the apparatus comprises the second capture device.

26. The apparatus of claim 15, wherein the apparatus comprises a network entity in communication with at least the second capture device.

27. A method, comprising:
detecting, during transmission of first and second data streams to a destination terminal, wherein the first data stream carries audio of a first sound source captured by a first capture device, and the second data stream carries audio of a second sound source captured by a second capture device, that the first sound source is in proximity of the second capture device such that the second capture device is capable of capturing the audio of the first sound source; and
suspending, at a particular time following said detection, transmission of the audio of the first sound source in the first data stream when the audio of the first sound source is captured by the second capture device and transmitted in the second data stream, the particular time being determined based on one or more characteristics of the audio captured by at least one of the first capture device or the second capture device.

28. The method of claim 27, wherein the particular time is a time at which the second capture device captures audio from the second sound source.

29. The method of claim 27, wherein the particular time is a time at which the first capture device captures no audio from the first sound source.

30. The method of claim 27, wherein suspending transmission of the audio of the first sound source in the first data stream comprises, at the particular time, disabling capture of the audio of the first sound source by the first capture device.

31. The method of claim 30, further comprising enabling capture of the audio of the first sound source by the second capture device at the particular time.

32. The method of claim 27, wherein suspending transmission of the audio of the first sound source in the first data stream comprises suspending transmission of the first data stream.

33. The method of claim 27, further comprising:
further detecting, after suspending transmission of the first data stream, that the first sound source is no longer in proximity of the second capture device; and
responsive to said further detecting, resuming the transmission of the first data stream, wherein the audio of the first sound source is captured by the first capture device and transmitted in the first data stream.

34. A non-transitory computer readable medium comprising program instructions stored thereon for performing at least the following:
detecting, during transmission of first and second data streams to a destination terminal, wherein the first data stream carries audio of a first sound source captured by a first capture device, and the second data stream carries audio of a second sound source captured by a second capture device, that the first sound source is in proximity of the second capture device such that the second capture device is capable of capturing the audio of the first sound source; and
suspending, at a particular time following said detection, transmission of the audio of the first sound source in the first data stream when the audio of the first sound source is captured by the second capture device and transmitted in the second data stream, the particular time being determined based on one or more characteristics of the audio captured by at least one of the first capture device or the second capture device.
